(19) United States
(12) Patent Application Publication
(10) Pub. No.: US 2009/0088524 A1
(43) Pub. Date: Apr. 2, 2009

(54) CURABLE SILICONE COMPOSITIONS

(75) Inventor: Andreas Koellnberger, Pilsting (DE)

Correspondence Address: BROOKS KUSHMAN P.C., 1000 TOWN CENTER, TWENTY-SECOND FLOOR, SOUTHFIELD, MI, 48075, US

(73) Assignee: Wacker Chemie AG, Munich (DE)

(21) Appl. No.: 12/240,109

(22) Filed: Sep. 29, 2008

(30) Foreign Application Priority Data
Oct. 2, 2007 (DE) 10 2007 047 212.0

(51) Int. Cl. C08L 83/05; B01J 31/18

(52) U.S. Cl. 524/588; 502/162; 525/478

(57) ABSTRACT

The present invention relates to silicone compositions which can be crosslinked thermally by hydrosilylation, a process for producing them, platinum catalysts used for this purpose and the use of the crosslinkable compositions.

### BACKGROUND OF THE INVENTION

1. Field of the Invention

The present invention relates to silicone compositions which can be crosslinked thermally by hydrosilylation, to a process for producing them, to platinum catalysts used for this purpose, and to use of the crosslinkable compositions.

2. Background Art

To crosslink addition-crosslinking silicone compositions by means of a hydrosilylation reaction, catalysts which typically contain platinum or a metal of the platinum group are generally used. In the catalytic reaction, aliphatic unsaturated groups are reacted with Si-bonded hydrogen to form network structures.

In the case of two-component systems, the reactive constituents are mixed only shortly before processing. The mixtures contain an active platinum catalyst, as a result of which the crosslinking reaction proceeds even at room temperature and the time to processing (potlife) is subject to strict limits. This results in disadvantages such as an additional mixing step, an increased need for cleaning in the case of technical malfunctions and the risk of platinum contamination in vessels.

There has long been a need for one-component addition-crosslinking silicone rubber systems which ideally do not cure at all at room temperature, but cure very quickly at elevated temperature.

Various approaches have been used to try to solve the problem of premature crosslinking at room temperature. One possibility is the use of inhibitors which are added as additives to the mixture in order to increase the potlife. The inhibitors are always used in a molar excess over the catalyst component and decrease the catalytic activity of the latter. However, as the amount of inhibitor increases, not only does the potlife increase but the reactivity of the system at higher temperatures also decreases and the initiation temperature increases as well. There are numerous examples of inhibitors from various classes of substances in the literature. U.S. Pat. No. 3,723,567 claims aminofunctional silanes as inhibitors. Alkyldiamines in combination with an acetylenically unsaturated alcohol are used for inhibition in U.S. Pat. No. 5,270,422. EP 0 761 759 A2 claims a combination of inhibitors; a phosphite together with further inhibitors such as maleates and ethynols is used. DE 19 757 221 A1 likewise describes the class of phosphites for use as an inhibitor. Phosphines are claimed as an additive for inhibition in U.S. Pat. No. 4,329,275. A combination of phosphites with organic peroxides is described in EP 1 437 382 A1. Apart from adverse effects on the crosslinking kinetics, the use of volatile inhibitors or inhibitors which liberate volatile constituents is likewise disadvantageous. Mixtures which achieve complete inhibition at room temperature and do not display any influence at all on the reaction rate by a corresponding additive under curing conditions have not been known up to the present.

A further possibility which is fundamentally different from use of inhibitors is to encapsulate the catalyst in a thermoplastic material which melts at elevated temperature and thereby liberates the active catalyst, as described, for example, in EP 0 459 464 A2. However, the production of the catalyst is relatively complicated.

A third possibility for preventing premature crosslinking of one-component systems at room temperature is the use of specific platinum complexes. Platinum-alkynyl complexes are described in U.S. Pat. No. 6,252,028 and U.S. Pat. No. 6,359,098. In U.S. Pat. No. 4,256,616, Pt(0)-phosphine and -phosphite complexes are used in combination with tin salts, and WO 03/098 890 A1 describes Pt(0)-phosphite complexes which contain both phosphite ligands and divinyldisiloxane ligands as structural features.

Although the compositions described provide significantly improved potlives at sometimes sufficiently high crosslinking rates in the case of addition-crosslinking compositions formulated as one component systems, there continues to be a need for higher-performance platinum catalysts which ensure rapid crosslinking of the material at elevated temperature but do not display the abovementioned disadvantages.

### SUMMARY OF THE INVENTION

It was an object of the present invention to provide addition-crosslinking compositions which do not display the abovementioned disadvantages and make possible not only improved potlives but also improved crosslinking rates. These and other objects have been surprisingly achieved through use of a new class of platinum hydrosilylation catalysts which are substituted bis(tris-hydrocarbon phosphite) platinum compounds.

### DETAILED DESCRIPTION OF THE PREFERRED EMBODIMENT(S)

In the following, the term organopolysiloxanes encompasses polymeric, oligomeric and dimeric siloxanes. The present patent application thus provides addition-crosslinking silicone compositions containing
at least one of each of the compounds (A), (B) and (D),
at least one of each of the compounds (C) and (D), or
at least one of each of the compounds (A), (B), (C) and (D)
where
(A) is an organic compound or an organosilicon compound comprising at least two radicals having aliphatic carbon-carbon multiple bonds,
(B) is an organosilicon compound containing at least two Si-bonded hydrogen atoms,
(C) is an organosilicon compound containing SiC-bonded radicals having aliphatic carbon-carbon multiple bonds and Si-bonded hydrogen atoms, and
(D) is a platinum catalyst,

wherein the platinum catalyst (D) corresponds to the general formula (I),

R¹₂Pt[P(OR²)₃]₂ (I)

where
R¹ are identical or different and are each, independently of one another,
a halogen,
a singularly negatively charged inorganic radical,
CR³₃ where the radicals R³ are identical or different and are each, independently of one another, H, a linear or branched aliphatic radical having from 1 to 18 carbon atoms or an arylalkyl radical having from 6 to 31 carbon atoms,
OR³ where R³ is as defined above,
SiR³₃ where R³ is as defined above, the radicals R² are identical or different and are each, independently of one another,
an alkyl radical of the formula CₙH₂ₙ₊₁ where n=5-18 or CₘH₂ₘ₋₁ where m=5-31,
an arylalkyl radical of the formula —(C₆H₅₋ₚ)—(CₒH₂ₒ₊₁)ₚ where o=1-31 and p=1-5,
   where the compounds mentioned above for R¹ and R² may be unsubstituted or substituted by the groups —NH₂, —COOH, F, —Br, —Cl, aryl or -alkyl.

It has been found that the platinum catalysts (D), in particular Pt(II)-phosphite complexes in which platinum in the oxidation state +II is present as central metal and phosphorus is in the oxidation state +III, lead to the improved properties of the silicone compositions of the invention.

The compositions of the invention can be either one-component silicone compositions or two-component silicone compositions. In the latter case, the two components of the compositions of the invention can contain all constituents in any combination, generally with the proviso that one component does not simultaneously contain siloxanes having an aliphatic multiple bond, siloxanes having Si-bonded hydrogen and catalysts, i.e. essentially does not simultaneously contain the constituents (A), (B) and (D), or (C) and (D). However, the compositions of the invention are preferably one-component compositions.

The compounds (A) and (B) or (C) used in the compositions of the invention are, as is known, selected so that crosslinking is possible. Thus, for example, compound (A) has at least two aliphatically unsaturated radicals and (B) has at least three Si-bonded hydrogen atoms, or compound (A) has at least three aliphatically unsaturated radicals and siloxane (B) has at least two Si-bonded hydrogen atoms, or else siloxane (C) which has aliphatically unsaturated radicals and Si-bonded hydrogen atoms in the abovementioned ratios is used instead of compounds (A) and (B). Mixtures of (A) and (B) and (C) with the abovementioned ratios of aliphatically unsaturated radicals and Si-bonded hydrogen atoms are also possible.

The compound (A) used according to the invention can be a silicon-free organic compound which preferably has at least two aliphatically unsaturated groups or an organosilicon compound which preferably has at least two aliphatically unsaturated groups or a mixture thereof.

Examples of silicon-free organic compounds (A) are 1,3,5-trivinylcyclohexane, 2,3-dimethyl-1,3-butadiene, 7-methyl-3-methylene-1,6-octadiene, 2-methyl-1,3-butadiene, 1,5-hexadiene, 1,7-octadiene, 4,7-methylene-4,7,8,9-tetrahydroindene, methylcyclopentadiene, 5-vinyl-2-norbornene, bicyclo[2.2.1]hepta-2,5-diene, 1,3-diisopropenylbenzene, polybutadiene containing vinyl groups, 1,4-divinylcyclohexane, 1,3,5-triallylbenzene, 1,3,5-trivinylbenzene, 1,2,4-trivinylcyclohexane, 1,3,5-triisopropenylbenzene, 1,4-divinylbenzene, 3-methyl-1,5-heptadiene, 3-phenyl-1,5-hexadiene, 3-vinyl-1,5-hexadiene and 4,5-dimethyl-4,5-diethyl-1,7-octadiene, N,N′-methylenebisacrylamide, 1,1,1-tris(hydroxymethyl)propane triacrylate, 1,1,1-tris(hydroxymethyl)propane trimethacrylate, tripropylene glycol diacrylate, diallyl ether, diallylamine, diallyl carbonate, N,N′-diallylurea, triallylamine, tris(2-methylallyl)amine, 2,4,6-triallyloxy-1,3,5-triazine, triallyl-s-triazine-2,4,6(1H,3H,5H)-trione, diallylmalonic esters, polyethylene glycol diacrylate, polyethylene glycol dimethacrylate, and poly(propylene glycol) methacrylate.

The silicone compositions of the invention preferably contain at least one aliphatically unsaturated organosilicon compound, with all aliphatically unsaturated organosilicon compounds useful in addition-crosslinking compositions being able to be used, for example silicone block copolymers having urea segments, silicone block copolymers having amide segments and/or imide segments and/or ester amide segments and/or polystyrene segments and/or silarylene segments and/or carborane segments and silicone graft copolymers having ether groups, as constituent (A).

As organosilicon compounds (A) which have SiC-bonded radicals having aliphatic carbon-carbon multiple bonds, preference is given to using linear or branched organopolysiloxanes comprising units of the general formula (II)

RₐR⁴_{b}SiO_{(4-a-b)/2} (II)

where
the radicals R are identical or different and are each, independently of one another, an organic or inorganic radical which is free of aliphatic carbon-carbon multiple bonds,
the radicals R⁴ are identical or different and are each, independently of one another, a monovalent, substituted or unsubstituted, SiC-bonded hydrocarbon radical having at least one aliphatic carbon-carbon multiple bond,
a is 0, 1, 2 or 3 and
b is 0, 1 or 2,
   with the proviso that the sum a+b is less than or equal to 3 and at least two radicals R⁴ are present per molecule.

The radical R can be a monovalent or polyvalent radical, with polyvalent radicals, for example bivalent, trivalent or tetravalent radicals, then joining a plurality of, for instance 2, 3 or 4, siloxy units of the formula (II) to one another.

Further examples of R are the monovalent radicals —F, —Cl, —Br, OR⁵, —CN, —SCN, —NCO and SiC-bonded, substituted or unsubstituted hydrocarbon radicals which may be interrupted by oxygen atoms or the group —C(O)— and also divalent radicals which are Si-bonded on both sides as per formula (II). If the radical R is an SiC-bonded, substituted hydrocarbon radical, preferred substituents are halogen atoms, phosphorus-containing radicals, cyano radicals, —OR⁵, —NR⁵—, —NR⁵₂, —NR⁵—C(O)—NR⁵₂, —C(O)—NR⁵₂, —C(O)R⁵, —C(O)OR⁵, —SO₂-Ph and —C₆F₅. Here, the radicals R⁵ are identical or different and are each, independently of one another, a hydrogen atom or a monovalent hydrocarbon radical having from 1 to 20 carbon atoms and Ph is the phenyl radical.

Examples of radicals R are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical and octadecyl radicals such as the n-octadecyl radical; cycloalkyl radicals such as the cyclopentyl, cyclohexyl, cycloheptyl and methylcyclohexyl radicals; aryl radicals such as the phenyl, naphthyl, anthryl or phenanthryl radicals; alkaryl radicals such as the o-, m-, and p-tolyl radicals, xylyl radicals; and ethylphenyl radicals, and aralkyl radicals such as the benzyl radical and the α- and β-phenylethyl radicals.

Examples of substituted radicals R are haloalkyl radicals such as the 3,3,3-trifluoro-n-propyl radical, the 2,2,2,2′,2′,2′-hexafluoroisopropyl radical, the heptafluoroisopropyl radical, haloaryl radicals, such as the o-, m- or p-chlorophenyl radicals, —(CH₂)—N(R⁵)C(O)NR⁵₂, —(CH₂)ₙ—C(O)NR⁵₂, —(CH₂)ₙ—C(O)R⁵, —(CH₂)ₙ—C(O)OR⁵, —(CH₂)ₙ—C(O)NR⁵₂, —(CH₂)—C(O)—(CH₂)ₘC(O)CH₃, —(CH₂)—O—CO—R⁵, —(CH₂)—NR⁵—(CH₂)ₘ—NR⁵₂, —(CH₂)ₙ—O—(CH₂)ₘCH (OH) CH₂OH, —(CH₂)ₙ(OCH₂CH₂)ₘOR⁵, —(CH₂)ₙ—SO₂-Ph and —(CH₂)—O—C₆F₅, where R⁵ and Ph are as defined above and n and m are identical or different integers in the range from 0 to 10.

Examples of divalent radicals R which are Si-bonded on both sides as per formula (II) are radicals derived from the monovalent examples mentioned above for radical R by an additional bond being formed by replacement of a hydrogen atom; examples of such radicals are —(CH₂)—, —CH(CH₃)—, —C(CH₃)₂—, —CH(CH₃)—CH₂—, —C₆H₄—, —CH(Ph)-CH₂—, —C(CF₃)₂—, —(CH₂)ₙ—C₆H₄—(CH₂)ₙ—, —(CH₂)ₙ—C₆H₄—C₆H₄—(CH₂)ₙ—, —(CH₂O)ₘ, (CH₂CH₂O)ₘ, and —(CH₂)ₙ—Oₓ—C₆H₄—SO₂—C₆H₄—Oₓ—(CH₂)ₙ—, where x is 0 or 1 and Ph, m and n are as defined above.

The radical R is preferably a monovalent, SiC-bonded, substituted or unsubstituted hydrocarbon radical which is free of aliphatic carbon-carbon multiple bonds and has from 1 to 18 carbon atoms, more preferably a monovalent, SiC-bonded hydrocarbon radical which is free of aliphatic carbon-carbon multiple bonds and has from 1 to 6 carbon atoms, in particular a methyl or phenyl radical.

The radical R⁴ can be any group which can undergo an addition reaction (hydrosilylation) with an SiH-functional compound. If the radical R⁴ is an SiC-bonded, substituted hydrocarbon radical, preferred substitutes are halogen atoms, cyano radicals and —OR⁵, where R⁵ is as defined above.

The radical R⁴ is preferably an alkenyl or alkynyl group having from 2 to 16 carbon atoms, e.g. a vinyl, allyl, methallyl, 1-propenyl, 5-hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl or styryl radical, with vinyl, allyl and hexenyl radicals being particularly preferred.

The molecular weight of the constituent (A) can vary within wide limits, for example in the range from 10² to 10⁶ g/mol. Thus, the constituent (A) can be, for example, a relatively low molecular weight alkenyl-functional oligosiloxane, e.g. 1,2-divinyltetramethyldisiloxane, but can also be a highly polymeric polydimethylsiloxane which has lateral or terminal Si-bonded vinyl groups, e.g. a polydimethylsiloxane of this type having a molecular weight of from 10⁵ g/mol (number average determined by means of NMR). The structure of the molecules forming the constituent (A) is also not fixed; in particular, the structure of a relatively high molecular weight, i.e. oligomeric or polymeric, siloxane can be linear, cyclic, branched or else resin-like, network-like. Linear and cyclic polysiloxanes are preferably composed of units of the formulae R₃SiO_{1/2}, R⁴R₂SiO_{1/2}, R⁴RSiO_{2/2} and R₂SiO_{2/2}, where R and R⁴ are as defined above. Branched and network-like polysiloxanes additionally contain trifunctional and/or tetrafunctional units, with preference being given to units of the formulae RSiO_{3/2}, R⁴SiO_{3/2} and SiO_{4/2}. Of course, mixtures of different siloxanes which satisfy the criteria of constituent (A) can also be used.

Particular preference is given to using vinyl-functional, essentially linear polydiorganosiloxanes having a viscosity of from 0.01 to 500,000 Pa·s, more preferably from 0.1 to 100,000 Pa·s, in each case at 25° C., as component (A).

As organosilicon compound (B), it is possible to use all hydrogen-functional organosilicon compounds are useful in addition-crosslinkable compositions. As organopolysiloxanes (B) which have Si-bonded hydrogen atoms, preference is given to using linear, cyclic or branched oligopolysiloxanes comprising units of the general formula (III)

R_{c}H_{d}SiO_{(4-c-d)/2} (III)

where

R is as defined above,

c is 0, 1 2 or 3 and

d is 0, 1 or 2,

with the proviso that the sum of c+d is less than or equal to 3 and at least two Si-bonded hydrogen atoms are present per molecule.

The organopolysiloxane (B) used according to the invention preferably contains Si-bonded hydrogen in an amount of from 0.04 to 1.7 percent by weight, based on the total weight of the organopolysiloxane (B). The molecular weight of the constituent (B) can likewise vary within wide limits, for example in the range from 10² to 10⁶ g/mol. Thus, the constituent (B) can be, for example, a relatively low molecular weight SiH-functional oligosiloxane, e.g. tetramethyldisiloxane, but can also be a highly polymeric polydimethylsiloxane having lateral or terminal SiH groups or a silicone resin having SiH groups.

The structure of the molecules forming the constituent (B) is also not fixed; in particular, the structure of a relatively high molecular weight, i.e. oligomeric or polymeric, SiH-containing siloxane can be linear, cyclic, branched or else resin-like, network-like. Linear and cyclic polysiloxanes (B) are preferably composed of units of the formulae R₃SiO_{1/2}, HR₂SiO_{1/2}, HRSiO_{2/2} and R₂SiO_{2/2}, where R is as defined above. Branched and network-like polysiloxanes additionally contain trifunctional and/or tetrafunctional units, with units of the formulae RSiO_{3/2}, HSiO_{3/2} and SiO_{4/2}, where R is as defined above, being preferred.

Of course, it is also possible to use mixtures of different siloxanes which satisfy the criteria of constituent (B). In particular, the molecules forming the constituent (B) can, if appropriate, contain aliphatic unsaturated groups in addition to the obligatory SiH groups. Particular preference is given to using low molecular weight SiH-functional compounds, e.g. tetrakis(dimethylsiloxy)silane and tetramethylcyclotetrasiloxane, and also relatively high molecular weight, SiH-containing siloxanes, e.g. poly(hydrogenmethyl)siloxane and poly(dimethylhydrogenmethyl)siloxane having a viscosity at 25° C. of from 10 to 10,000 mPa·s, or analogous SiH-containing compounds in which part of the methyl groups has been replaced by 3,3,3-trifluoropropyl or phenyl groups.

Constituent (B) is preferably present in the crosslinkable silicone compositions of the invention in such an amount that the molar ratio of SiH groups to aliphatic unsaturated groups from (A) is from 0.1 to 20, more preferably from 1.0 to 5.0. The components (A) and (B) are commercial products or can be prepared by methods customary in chemistry.

In place of components (A) and (B), it is possible for organopolysiloxanes (C) which at the same time have aliphatic carbon-carbon multiple bonds and Si-bonded hydrogen atoms to be present in the silicone compositions of the invention. It is also possible for all three components (A), (B) and (C) to be present in the silicone compositions of the invention.

If siloxanes (C) are used, they are preferably siloxanes comprising units of the general formulae (IV), (V) and (VI)

R_{f}SiO_{4-f/2} (IV)

R_{g}R⁴SiO_{3-g/2} (V)

RₕHSiO_{3-h/2} (VI)

where

R and R⁴ are as defined above,

f is 0, 1, 2 or 3,

g is 0, 1 or 2 and

h is 0, 1 or 2,

with the proviso that at least two radicals R⁴ and at least two Si-bonded hydrogen atoms are present per molecule.

Examples of organopolysiloxanes (C) are organopolysiloxanes comprising SiO_{4/2}, R₃SiO_{1/2}, R₂R⁴SiO_{1/2} and R₂HSiO_{1/2} units, known as MQ resins, with these resins additionally being able to contain RSiO_{3/2} and R₂SiO units, and also linear organopolysiloxanes consisting essentially of R₂R⁴SiO_{1/2}, R₂SiO and RHSiO units, where R and R¹¹ are as defined above.

The organopolysiloxanes (C) preferably have an average viscosity of from 0.01 to 500,000 Pa·s, particularly preferably from 0.1 to 100,000 Pa·s, in each case at 25° C. Organopolysiloxanes (C) can be prepared by methods customary in chemistry.

Addition-crosslinking silicone compositions according to the invention contain
at least one of each of the compounds (A), (B) and (D),
at least one of each of the compounds (C) and (D), or
at least one of each of the compounds (A), (B), (C) and (D),
where
(A) is an organic compound or an organosilicon compound containing at least two radicals having aliphatic carbon-carbon multiple bonds,
(B) an organosilicon compound containing at least two Si-bonded hydrogen atoms,
(C) an organosilicon compound containing SiC-bonded radicals having aliphatic carbon-carbon multiple bonds and Si-bonded hydrogen atoms, and
(D) is a platinum catalyst,
   where the platinum catalyst (D) corresponds to the following definition.

The invention further provides the component (D) which is critical for the properties of the silicone compositions of the invention. The platinum catalyst (D) of the invention corresponds to the general formula (I),

R¹₂Pt[P(OR²)₃]₂ (I)

where
the radicals R¹ are identical or different and are each, independently of one another,
a halogen,
a singularly negatively charged inorganic radical,
CR³₃ where the radicals R³ are identical or different and are each, independently of one another, H or a linear or branched aliphatic radical having from 1 to 18 carbon atoms or an arylalkyl radical having from 6 to 31 carbon atoms,
OR³ where R³ is as defined above,
SiR³₃ where R³ is as defined above,
   the radicals R² are identical or different and are each, independently of one another,
an alkyl radical of the formulae CₙH₂ₙ₊₁ where n=5-18 or CₘH₂ₘ₋₁ where m=5-31,
an arylalkyl radical of the formula —(C₆H₅₋ₚ)—(CₒH₂ₒ₋₁)ₚ where o=1-31 and p=1-5,
   where the compounds mentioned above for R¹ and R² may be unsubstituted or substituted by —NH₂, —COOH, —F, —Br, —Cl, -aryl or -alkyl groups.

(D) is a specially prepared platinum complex. It is prepared by reaction of a platinum salt such as K₂PtCl₄, Na₂PtCl₄, PtCl₂, PtBr₂ or PtI₂ with the respective phosphite of the formula [P(OR²)₃], where R² is as defined above, at a temperature of from 0 to 110° C. in a solvent which is suitable for the reaction. The phosphites used for this reaction are prepared by customary methods from the prior art or they are commercially available.

Before being mixed into the silicone composition of the invention, the compound (D) is isolated and its purity is checked by means of customary methods. The phosphite of the formula [P(OR²)₃] which is used coordinates to the central metal, where R² is as defined above.

An illustrative listing of platinum-phosphite complexes [D] according to the invention in which R¹=Cl and R² has been varied and which have been synthesized by the route described above is given below.
PtCl₂[P(—O-2-methylphenyl)₃]₂,
PtCl₂[P(—O-2-ethylphenyl)₃]₂,
PtCl₂[P(—O-2-propylphenyl)₃]₂,
PtCl₂[P(—O-2-isopropylphenyl)₃]₂,
PtCl₂[P(—O-2-butylphenyl)₃]₂,
PtCl₂[P(—O-2-sec-butylphenyl)₃]₂,
PtCl₂[P(—O-2-tert-butylphenyl)₃]₂,
PtCl₂[P(—O-2-pentylphenyl)₃]₂,
PtCl₂{P[—O-2-(1-methylbutyl)phenyl]₃}₂,
PtCl₂[P(—O-2-hexylphenyl)₃]₂,
PtCl₂[P(—O-2-heptylphenyl)₃]₂,
PtCl₂[P(—O-2-octylphenyl)₃]₂,
PtCl₂[P(—O-2-nonylphenyl)₃]₂,
PtCl₂[P(—O-2-decylphenyl)₃]₂,
PtCl₂[P(—O-2-octadecylphenyl)₃]₂,
PtCl₂[P(—O-2-octadecenylphenyl)₃]₂,
PtCl₂{P[—O-2-(1,1-dimethylpropyl)phenyl]₃}₂,
PtCl₂{P[—O-2-(1,1-dimethylbutyl)phenyl]₃}₂,
PtCl₂{P[—O-2-(1,1-dimethylpentyl)phenyl]₃}₂,
PtCl₂{P[—O-2-(1,1-dimethylhexyl)phenyl]₃}₂,
PtCl₂{P[—O-2-(1,1-dimethylheptyl)phenyl]₃}₂,
PtCl₂{P[—O-2-(1,1,3,3-tetramethylbutyl)phenyl]₃}₂,
PtCl₂[P(—O-4-methylphenyl)₃]₂,
PtCl₂[P(—O-4-ethylphenyl)₃]₂,
PtCl₂[P(—O-4-propylphenyl)₃]₂,
PtCl₂[P(—O-4-isopropylphenyl)₃]₂,
PtCl₂[P(—O-4-butylphenyl)₃]₂,
PtCl₂[P(—O-4-sec-butylphenyl)₃]₂,
PtCl₂[P(—O-4-tert-butylphenyl)₃]₂,
PtCl₂[P(—O-4-pentylphenyl)₃]₂,
PtCl₂{P[—O-4-(1-methylbutyl)phenyl]₃}₂,
PtCl₂[P(—O-4-hexylphenyl)₃]₂,
PtCl₂[P(—O-4-heptylphenyl)₃]₂,
PtCl₂[P(—O-4-octylphenyl)₃]₂,
PtCl₂[P(—O-4-nonylphenyl)₃]₂,
PtCl₂[P(—O-4-decylphenyl)₃]₂,
PtCl₂[P(—O-4-octadecylphenyl)₃]₂,
PtCl₂[P(—O-4-octadecenylphenyl)₃]₂,
PtCl₂{P[—O-4-(1,1-dimethylpropyl)phenyl]₃}₂,
PtCl₂{P[—O-4-(1,1-dimethylbutyl)phenyl]₃}₂,
PtCl₂{P[—O-4-(1,1-dimethylpentyl)phenyl]₃}₂,
PtCl₂{P[—O-4-(1,1-dimethylhexyl)phenyl]₃}₂,
PtCl₂{P[—O-4-(1,1-dimethylheptyl)phenyl]₃}₂,
PtCl₂{P[—O-4-(1,1,3,3-tetramethylbutyl)phenyl]₃}₂,
PtCl₂[P(—O-2,4-dimethylphenyl)₃]₂,
PtCl₂[P(—O-2,4-diethylphenyl)₃]₂,
PtCl₂[P(—O-2,4-dipropylphenyl)₃]₂,
PtCl₂[P(—O-2,4-diisopropylphenyl)₃]₂,
PtCl₂[P(—O-2,4-dibutylphenyl)₃]₂,
PtCl₂[P(—O-2,4-di-sec-butylphenyl)₃]₂,
PtCl₂[P(—O-2,4-di-tert-butylphenyl)₃]₂,
PtCl₂[P(—O-2,4-di-pentylphenyl)₃]₂,
PtCl₂{P[—O-2,4-bis(1-methylbutyl)phenyl]₃}₂,
PtCl₂[P(—O-2,4-dihexylphenyl)₃]₂,
PtCl₂[P(—O-2,4-diheptylphenyl)₃]₂,
PtCl₂[P(—O-2,4-dioctylphenyl)₃]₂,
PtCl₂[P(—O-2,4-dinonylphenyl)₃]₂,
PtCl₂[P(—O-2,4-didecylphenyl)₃]₂,
PtCl₂[P(—O-2,4-dioctadecylphenyl)₃]₂,
PtCl₂[P(—O-2,4-dioctadecenylphenyl)₃]₂,
PtCl₂{P[—O-2,4-bis(1,1-dimethylpropyl)phenyl]₃}₂,
PtCl₂{P[—O-2,4-bis(1,1-dimethylbutyl)phenyl]₃}₂,
PtCl₂{P[—O-2,4-bis(1,1-dimethylpentyl)phenyl]₃}₂,
PtCl₂{P[—O-2,4-bis(1,1-dimethylhexyl)phenyl]₃}₂,
PtCl₂{P[—O-2,4-bis(1,1-dimethylheptyl)phenyl]₃}₂,
PtCl₂{P[—O-2,4-bis(1,1,3,3-tetramethylbutyl)phenyl]₃}₂,
PtCl₂[P(—O-2,5-dimethylphenyl)₃]₂,
PtCl₂[P(—O-2,5-diethylphenyl)₃]₂,
PtCl₂[P(—O-2,5-dipropylphenyl)₃]₂,
PtCl₂[P(—O-2,5-diisopropylphenyl)₃]₂,
PtCl₂[P(—O-2,5-dibutylphenyl)₃]₂,
PtCl₂[P(—O-2,5-di-sec-butylphenyl)₃]₂,
PtCl₂[P(—O-2,5-di-tert-butylphenyl)₃]₂,
PtCl₂[P(—O-2,5-di-pentylphenyl)₃]₂,
PtCl₂{P[—O-2,5-bis(1-methylbutyl)phenyl]₃}₂,
PtCl₂[P(—O-2,5-dihexylphenyl)₃]₂,
PtCl₂[P(—O-2,5-diheptylphenyl)₃]₂,
PtCl₂[P(—O-2,5-dioctylphenyl)₃]₂,
PtCl₂[P(—O-2,5-dinonylphenyl)₃]₂,
PtCl₂[P(—O-2,5-didecylphenyl)₃]₂,
PtCl₂[P(—O-2,5-dioctadecylphenyl)₃]₂,
PtCl₂[P(—O-2,5-dioctadecenylphenyl)₃]₂,
PtCl₂{P[—O-2,5-bis(1,1-dimethylpropyl)phenyl]₃}₂,
PtCl₂{P[—O-2,5-bis(1,1-dimethylbutyl)phenyl]₃}₂,
PtCl₂{P[—O-2,5-bis(1,1-dimethylpentyl)phenyl]₃}₂,
PtCl₂{P[—O-2,5-bis(1,1-dimethylhexyl)phenyl]₃}₂,
PtCl₂{P[—O-2,5-bis(1,1-dimethylheptyl)phenyl]₃}₂,
PtCl₂{P[—O-2,5-bis(1,1,3,3-tetramethylbutyl)phenyl]₃}₂,
PtCl₂[P(—O-2,5-dimethyl-4-methoxyphenyl)₃]₂,
PtCl₂[P(—O-2,5-diethyl-4-methoxyphenyl)₃]₂,
PtCl₂[P(—O-2,5-dipropyl-4-methoxyphenyl)₃]₂,
PtCl₂[P(—O-2,5-diisopropyl-4-methoxyphenyl)₃]₂,
PtCl₂[P(—O-2,5-dibutyl-4-methoxyphenyl)₃]₂,
PtCl₂[P(—O-2,5-di-sec-butyl-4-methoxyphenyl)₃]₂,
PtCl₂[P(—O-2,5-di-tert-butyl-4-methoxyphenyl)₃]₂,
PtCl₂[P(—O-2,5-di-pentyl-4-methoxyphenyl)₃]₂,
PtCl₂{P[—O-2,5-bis(1-methylbutyl)-4-methoxyphenyl]₃}₂,
PtCl₂[P(—O-2,5-dihexyl-4-methoxyphenyl)₃]₂,
PtCl₂[P(—O-2,5-diheptyl-4-methoxyphenyl)₃]₂,
PtCl₂[P(—O-2,5-dioctyl-4-methoxyphenyl)₃]₂,
PtCl₂[P(—O-2,5-dinonyl-4-methoxyphenyl)₃]₂,
PtCl₂[P(—O-2,5-didecyl-4-methoxyphenyl)₃]₂,
PtCl₂[P(—O-2,5-dioctadecyl-4-methoxyphenyl)₃]₂,
PtCl₂[P(—O-2,5-dioctadecenyl-4-methoxyphenyl)₃]₂,
PtCl₂{P[—O-2,5-bis(1,1-dimethylpropyl)-4-methoxyphenyl]₃}₂,
PtCl₂{P[—O-2,5-bis(1,1-dimethylbutyl)-4-methoxyphenyl]₃}₂,
PtCl₂{P[—O-2,5-bis(1,1-dimethylpentyl)-4-methoxyphenyl]₃}₂,
PtCl₂{P[—O-2,5-bis(1,1-dimethylhexyl)-4-methoxyphenyl]₃}₂,
PtCl₂{P[—O-2,5-bis(1,1-dimethylheptyl)-4-methoxyphenyl]₃}₂,
PtCl₂{P[—O-2,5-bis(1,1,3,3-tetramethylbutyl)-4-methoxyphenyl]₃}₂,
PtCl₂[P(—O-2,5-dimethyl-4-ethoxyphenyl)₃]₂,
PtCl₂[P(—O-2,5-diethyl-4-ethoxyphenyl)₃]₂,
PtCl₂[P(—O-2,5-dipropyl-4-ethoxyphenyl)₃]₂,
PtCl₂[P(—O-2,5-diisopropyl-4-ethoxyphenyl)₃]₂,
PtCl₂[P(—O-2,5-dibutyl-4-ethoxyphenyl)₃]₂,
PtCl₂[P(—O-2,5-di-sec-butyl-4-ethoxyphenyl)₃]₂,
PtCl₂[P(—O-2,5-di-tert-butyl-4-ethoxyphenyl)₃]₂,
PtCl₂[P(—O-2,5-di-pentyl-4-ethoxyphenyl)₃]₂,
PtCl₂{P[—O-2,5-bis(1-methylbutyl)-4-ethoxyphenyl]₃}₂,
PtCl₂[P(—O-2,5-dihexyl-4-ethoxyphenyl)₃]₂,
PtCl₂[P(—O-2,5-diheptyl-4-ethoxyphenyl)₃]₂,
PtCl₂[P(—O-2,5-dioctyl-4-ethoxyphenyl)₃]₂,
PtCl₂[P(—O-2,5-dinonyl-4-ethoxyphenyl)₃]₂,
PtCl₂[P(—O-2,5-didecyl-4-ethoxyphenyl)₃]₂,
PtCl₂[P(—O-2,5-dioctadecyl-4-ethoxyphenyl)₃]₂,
PtCl₂[P(—O-2,5-dioctadecenyl-4-ethoxyphenyl)₃]₂,
PtCl₂{P[—O-2,5-bis(1,1-dimethylpropyl)-4-ethoxyphenyl]₃}₂,
PtCl₂{P[—O-2,5-bis(1,1-dimethylbutyl)-4-ethoxyphenyl]₃}₂,
PtCl₂{P[—O-2,5-bis(1,1-dimethylpentyl)-4-ethoxyphenyl]₃}₂,
PtCl₂{P[—O-2,5-bis(1,1-dimethylhexyl)-4-ethoxyphenyl]₃}₂,
PtCl₂{P[—O-2,5-bis(1,1-dimethylheptyl)-4-ethoxyphenyl]₃}₂,
PtCl₂{P[—O-2,5-bis(1,1,3,3-tetramethylbutyl)-4-ethoxyphenyl]₃}₂,
PtCl₂{P[(—O-2-tert-butyl-5-methylphenyl)(—O-2,4-di-tert-butylphenyl)₂]}₂,
PtCl₂{P[(—O-2,4-di-tert-pentylphenyl)(—O-2,4-di-tert-butylphenyl)₂]}₂, and
PtCl₂{P[(—O-2-tert-butylphenyl)(—O-2,4-di-tert-butylphenyl)₂]}₂,

An illustrative listing of platinum-phosphite complexes [D] according to the invention in which R¹ has been varied and R² is in each case a phosphite compound (=phosphite) and which are likewise synthesized by the above-described route is given below:
PtF₂(phosphite)₂,
PtBr₂(phosphite)₂,
PtI₂(phosphite)₂,
Pt(CH₃)₂(phosphite)₂,
Pt(CH₂CH₃)₂(phosphite)₂,
Pt[(CH₂)₂CH₃]₂(phosphite)₂,
Pt[(CH₂)₃CH₃]₂(phosphite)₂,
Pt[(CH₂)₄CH₃]₂(phosphite)₂,
Pt[(CH₂)₅CH₃]₂(phosphite)₂,
Pt[(CH₂)₆CH₃]₂(phosphite)₂,
Pt[(CH₂)₇CH₃]₂(phosphite)₂,
Pt[(CH₂)₁₇CH₃]₂(phosphite)₂,
Pt[C(CH₃)₂CH₃]₂(phosphite)₂,
Pt[C(CH₃)₂CH₂CH₃]₂(phosphite)₂,
Pt[C(CH₃)₂(CH₂)₂CH₃]₂(phosphite)₂,
Pt[C(CH₃)₂(CH₂)₃CH₃]₂(phosphite)₂,
Pt[C(CH₃)₂(CH₂)₄CH₃]₂(phosphite)₂,
Pt(OCH₃)₂(phosphite)₂,
Pt(OCH₂CH₃)₂(phosphite)₂,
Pt[O(CH₂)₂CH₃]₂(phosphite)₂,
Pt[O(CH₂)₃CH₃]₂(phosphite)₂, and
Pt[Si(CH₃)₃]₂(phosphite)₂.

The platinum catalysts (D) of the invention are not restricted to the abovementioned examples since many substituents can be used as R¹. The radicals R¹ can be, independently of one another, monovalent radicals which are able to form a complex having no overall charge from the central metal platinum in the oxidation state +II which bears two phosphite ligands.

Examples of R¹ as singularly negatively charged inorganic radical are pseudo halides selected from the group consisting of N₃⁻, CN⁻, OCN⁻, CNO⁻, SCN⁻, NCS⁻, SeCN⁻. Halogens, pseudo halogens and alkyl radicals are preferred as radicals R¹.

Examples of R¹ are —Cl and also —F, —Br, —I, —CN, —N₃, —OCN, —NCO, —CNO, —SCN, —NCS, —SeCN, —CH₃, —CH₂CH₃, —CH(CH₃)₂, —C(CH₃)₃, —C₆H₅, —CH₂(Ph)-CH₃, CᵥH₂ᵥ₊₁, CᵥH₂ᵥ₋₁, —(C₆H_{5-w})—(CᵥH₂ᵥ₊₁)_{w} where v=1-18 and w=1-5, —O-alkyl, —O-aryl, —O-arylalkyl, —Si(alkyl)₃, —Si(aryl)₃, —Si(arylalkyl)₃. Particularly preferred radicals R¹ are halogens and linear or branched aliphatic radicals having from 1 to 18 carbon atoms in which the H atoms may, if appropriate, be replaced by groups such as —NH₂, —COOH, F, Br, Cl, -alkyl, -aryl or -arylalkyl.

Preferred radicals R² are alkyl radicals. Examples of R² are n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical and octadecyl radicals such as the n-octadecyl radical.

Further preferred radicals R² are arylalkyl radicals —(C₆H₅₋ₚ)—(CₒH₂ₒ₊₁)ₚ where o is 1-18 and p is 1-5, with particular preference being given to o being 1-18 and p being 2-3. In a further particularly preferred embodiment for R², at least one alkyl substituent is present in the 2 position of the phenyl ring in the arylalkyl radical. Compared to unsubstituted arylalkyl phosphites, platinum complexes having substituted phosphites have the advantage of a significantly lower reaction commencement temperature.

The platinum catalysts (D) of the invention are useful as catalysts for the well-known hydrosilylation reaction in organosilicon chemistry, as catalyst for the hydrogenation of unsaturated organic compounds or polymers and for the oligomerization of acetylenes and other alkynes.

The platinum catalysts (D) of the invention have the further advantage that terminal double bonds are not rearranged to an internal position in the hydrosilylation, which would leave a relatively unreactive isomerized starting material. Furthermore, the platinum catalysts of the invention have the advantage that no platinum colloids are formed and no discoloration results from their use.

In addition to the above-mentioned components (A), (B), (C) and (D), it is possible for further components (E), (F) or (G) to be present in the silicone compositions of the invention.

Components (E) such as inhibitors and stabilizers serve to set the processing time, reaction commencement temperature and crosslinking rate of the silicone compositions of the invention in a targeted manner. These inhibitors and stabilizers are very well known in the field of addition-crosslinking compositions. Examples of inhibitors which can be employed are acetylenic alcohols such as 1-ethynyl-1-cyclohexanol, 2-methyl-3-butyn-2-ol and 3,5-dimethyl-1-hexyn-3-ol, 3-methyl-1-dodecyn-3-ol, polymethylvinylcyclosiloxanes such as 1,3,5,7-tetravinyltetramethyltetracyclosiloxane, low molecular weight silicone oils having methylvinyl-SiO_{1/2} groups and/or R₂vinylSiO_{1/2}— end groups, e.g. divinyltetramethydisiloxane, tetravinyldimethyldisiloxane, trialkyl cyanurates, alkyl maleates such as diallyl maleate, dimethyl maleate and diethyl maleate, alkyl fumarate such as diallyl fumarate and diethyl fumarate, organic hydroperoxides such as cumene hydroperoxide, tert-butyl hydroperoxide and pinane hydroperoxide, organic peroxides, organic sulfoxides, organic amines, diamines and amides, phosphanes and phosphites, nitriles, triazoles, diaziridines and oximes. The action of these inhibitor additives (E) depends on their chemical structure, so that the concentration has to be determined individually. Inhibitors and inhibitor mixtures are preferably used in a proportion of from 0.00001% to 5%, based on the total weight of the mixture, preferably from 0.00005 to 2% and most preferably from 0.0001 to 1%.

Components (F) are all further additives which are useful for producing addition-crosslinkable compositions. Examples of reinforcing fillers which can be used as component (F) in the silicone compositions of the invention are pyrogenic or precipitated silicas having BET surface areas of at least 50 m²/g and also carbon blacks and activated carbons such as furnace black and acetylene black, with preference being given to pyrogenic and precipitated silicas having BET surface areas of at least 50 m²/g. The silica fillers mentioned can be hydrophilic in character or can have been hydrophobicized by known methods. When hydrophilic fillers are mixed in, the addition of a hydrophobicizing agent is generally necessary. The amount of actively reinforcing filler (F) present in the crosslinkable composition according to the invention is in the range from 0 to 70% by weight, preferably from 0 to 50% by weight.

If desired, the silicone composition of the invention can contain a proportion of up to 70% by weight, preferably from 0.0001 to 40% by weight, of component (F) as further additives. These additives can be, for example, inactive fillers, resin-like polyorganosiloxanes which are different from the siloxanes (A), (B) and (C), reinforcing and nonreinforcing fillers, fungicides, fragrances, rheological additives, corrosion inhibitors, oxidation inhibitors, light stabilizers, flame retardants and agents for influencing the electrical properties, dispersants, solvents, bonding agents, pigments, dyes, plasticizers, organic polymers, heat stabilizers, etc. These include additives such as quartz flour, diatomaceous earth, clays, chalk, lithopone, carbon blacks, graphite, metal oxides, metal carbonates, sulfates, metal salts of carboxylic acids, metal dusts, fibers such as glass fibers, synthetic fibers, polymer powders, metal dusts, dyes, pigments, etc.

The silicone composition of the invention can, if desired, contain at least one further addition-crosslinking catalyst which corresponds to the prior art, for example hydrosilylation catalysts or peroxides, as further a component (G). Examples of such catalysts (G) are metallic and finely divided platinum which may be present on supports such as silicon dioxide, aluminum oxide or activated carbon, compounds or complexes of platinum, e.g. platinum halides such as PtCl₄, H₂PtCl₆.6H₂O, Na₂PtCl₄.4H₂O, platinum-olefin complexes, platinum-alcohol complexes, platinum-alkoxide complexes, platinum-ether complexes, platinum-aldehyde complexes, platinum-ketone complexes including reaction products of H₂PtCl₆.6H₂O and cyclohexanon, platinum-vinylsiloxane complexes such as platinum-1,3-divinyl-1,1,3,3-tetramethyl disiloxane complexes with or without a content of detectable inorganically bound halogen, bis(gamma-picoline)platinum dichloride, trimethylenedipyridineplatinum dichloride, dicyclopentadieneplatinum dichloride, (dimethyl sulfoxide)ethyleneplatinum(II) dichloride, cyclooctadieneplatinum dichloride, norbornadieneplatinum dichloride, gamma-picolineplatinum dichloride, cyclopentadieneplatinum dichloride and reaction products of platinum tetrachloride with olefin and primary amine or secondary amine or primary and secondary amine, e.g. the reaction product of platinum tetrachloride dissolved in 1-octene with sec.-butylamine, or ammonium-platinum complexes.

Further examples of such a catalyst (G) are organic peroxides such as acyl peroxide, e.g. dibenzoyl peroxide, bis(4-chlorobenzoyl) peroxide, bis(2,4-dichlorobenzoyl) peroxide and bis(4-methylbenzoyl) peroxide; alkyl peroxides and aryl peroxides, e.g. di-tert-butyl peroxide, 2,5-bis(tert-butylperoxy)-2,5-dimethylhexane, dicumyl peroxide and 1,3-bis(tert-butylperoxyisopropyl)benzene; perketals such as 1,1-bis(tert-butylperoxy)-3,3,5-trimethylcyclohexane; peresters such as diacetyl peroxydicarbonate, tert-butyl perbenzoate, tert-butylperoxy isopropyl carbonate, tert-butylperoxy isononanoate, dicyclohexyl peroxydicarbonate and 2,5-dimethylhexane 2,5-diperbenzoate.

The silicone compositions of the invention can, if necessary, be dissolved, dispersed, suspended or emulsified in liquids. The compositions of the invention can, depending, in particular, on the viscosity of the constituents and the filler content, have a low viscosity and be pourable, have a paste-like consistency, be pulverant, or may be malleable, high-viscosity compositions, as can be the case, as is known, for compositions frequently referred to in technical circles as RTV-1, RTV-2, LSR and HTV compositions. In particular, the compositions of the invention can, if they have a high viscosity, be prepared in the form of granules. Here, the individual granule can contain all components or the components used according to the invention can be incorporated separately into different individual granules. As regards the elastomeric properties of the crosslinked silicone compositions of the invention, the total range beginning with extremely soft silicone gels, through rubber-like materials to highly crosslinked silicones having glass-like behavior is likewise encompassed.

The silicone compositions of the invention can be produced by known methods, for example by homogeneous mixing of the individual components. The order is immaterial, but preference is given to homogeneous mixing of the platinum catalyst (D) and, if appropriate, (G) with a mixture of (A), (B) and if appropriate (E) and (F). The platinum catalyst (D) used according to the invention and if appropriate (G) can be incorporated as solid or as solution in a suitable solvent or as masterbatch homogeneously mixed with a small amount of (A) or (A) together with (E).

The components (A) to (G) used according to the invention can each be a single type of such a component or a mixture of at least two different types of such a component. The silicon compositions which can be crosslinked according to the invention by addition of Si-bonded hydrogen onto an aliphatic multiple bond can be crosslinked under the same conditions as the previously known compositions which can be crosslinked by means of a hydrosilylation reaction. Temperatures employed are preferably in the range from 100 to 220° C., more preferably from 130 to 190° C., and at pressures from 900 to 1100 hPa. However, it is also possible to employ higher or lower temperatures and pressures.

The present invention further provides shaped bodies produced by crosslinking of the compositions of the invention.

The silicone compositions of the invention and the crosslinking products produced therefrom according to the invention can be used for all purposes for which organopolysiloxane compositions which can be crosslinked to form elastomers or elastomers are useful. These encompass, for example, silicone coating or impregnation of any substrates, the production of shaped bodies, for example by injection molding, vacuum extrusion, extrusion, casting in a mold and pressing in a mold and also making of impressions, use as sealing, embedding and potting compositions, etc.

The crosslinkable silicone compositions of the invention have the advantage that they can be produced in a simple process using readily available starting materials and therefore economically. The crosslinkable compositions of the invention have the further advantage that they have a good storage stability as one-component formulations at 25° C. and ambient pressure and crosslink rapidly only at elevated temperature. The silicone compositions of the invention have the advantage that as two-component formulations they give, after mixing of the two components, a crosslinkable silicone composition which remains processable over a long period of time at 25° C. and ambient pressure, i.e. has an extremely long potlife, and crosslinks rapidly only at elevated temperature.

In the production of the crosslinkable compositions of the invention, it is of great advantage that the platinum catalyst (D) can be metered readily and incorporated easily. Furthermore, the compositions of the invention have the advantage that the crosslinked silicone rubbers obtained therefrom have excellent transparency. The compositions of the invention have the further advantage that the hydrosilylation reaction does not slow down with increasing reaction time.

### EXAMPLES

In the examples described below, all parts and percentages are, unless indicated otherwise, by weight. Unless indicated otherwise, the examples which follow are carried out at the pressure of the surrounding atmosphere, i.e. at about 1000 hPa, and at room temperature, i.e. at about 20° C., or at a temperature which is established on combining the reactants at room temperature without additional heating or cooling. In the following, all viscosities are at a temperature of 25° C.

### Preparation of Catalyst 1

A suspension of 2.08 g of K₂PtCl₄ in 40 ml of abs. ethanol and a solution of 4.79 g of tris(2-tert-butylphenyl) phosphite in 20 ml of abs. ethanol were combined under nitrogen and heated at the boiling point for one hour. The solvent was taken off and the residue was taken up in 40 ml of diethyl ether. The ether solution was extracted three times with 20 ml each time of water. The organic phase is dried over magnesium sulfate, filtered through a fluted filter paper and evaporated. This gave 5.50 g of a platinum complex having the following formula:

PtCl₂[P(—O-2-tert-butylphenyl)₃]₂.

### Preparation of Catalyst 2

A suspension of 2.08 g of K₂PtCl₄ in 40 ml of water and 6.89 g of tris(4-nonylphenyl) phosphite were combined under nitrogen and heated at the boiling point for one hour. This results in precipitation of the product as a white solid. After filtration, the product is washed with EtOH. This gave 6.95 g of a platinum complex having the following formula:

PtCl₂[P(—O-4-nonylphenyl)₃]₂.

### Preparation of Catalyst 3

A suspension of 1.33 g of PtCl₂ in 40 ml of dichloromethane and a solution of 9.05 g of tris(1,1-dimethylbutyl-4-methoxyphenyl) phosphite in 20 ml of dichloromethane were combined under nitrogen and heated at the boiling point for one hour. After taking off the solvent, the residue is taken up in diethyl ether and dried over magnesium sulfate. After filtration through a glass frit, the filtrate is evaporated. This gave 7.54 g of a platinum complex having the following formula:

PtCl₂{P[—O-2,5-bis(1,1-dimethylbutyl-4-methoxyphenyl)]₃}₂.

### Preparation of Catalyst 4

A suspension of 1.33 g of PtCl₂ in 40 ml of acetonitrile and a solution of 6.05 g of bis(2,4-di-tert-butylphenyl) 2-tert-butyl-5-methylphenyl phosphite in 20 ml of acetonitrile were combined under nitrogen and heated at the boiling point for one hour. This results in precipitation of the product as an oil. The solvent is taken off, the oily residue is taken up in 30 ml of diethyl ether and dried over sodium sulfate. After filtration, the solvent is taken off. This gave 5.95 g of a platinum complex having the following formula:

PtCl₂[P(—O-2,4-di-tert-butylphenyl)₂)-(—O-2-tert-butyl-5-methylphenyl)]₂.

### Preparation of Catalyst 5

A suspension of 1.33 g of PtCl₂ in 40 ml of acetonitrile and a solution of 6.47 g of tris(2,4-di-tert-butylphenyl) phosphite in 20 ml of acetonitrile were combined under nitrogen and heated at the boiling point for one hour. This results in precipitation of the product. The suspension is cooled to 20° C. After filtration through a glass filter, the product is dried. This gave 5.83 g of a platinum complex having the following formula:

PtCl₂[P(—O-2,4-di-tert-butylphenyl)₃]₂.

### Preparation of Catalyst 6

A suspension of 2.08 g of K₂PtCl₄ in 40 ml of abs. ethanol and a solution of 7.31 g of tris(isodecyl) phosphite in 20 ml of abs. ethanol were combined under nitrogen and heated at the boiling point for one hour. The solvent was taken off and the residue was taken up in 40 ml of diethyl ether. The ethyl solution was extracted three times with 20 ml each time of water. The organic phase is dried over magnesium sulfate, filtered through a fluted filter paper and evaporated. This gave 7.15 g of a platinum complex having the following formula:

PtCl₂[P(—O-isodecyl)₃]₂.

### Preparation of Catalyst 7

A suspension of 1.33 g of PtCl₂ in 40 ml of acetonitrile and a solution of 5.63 g of tris(2-tert-butyl-4-ethyl) phosphite in 20 ml of acetonitrile were combined under nitrogen and heated at the boiling point for one hour. This results in precipitation of the product. The suspension is cooled to 20° C. After filtration through a glass filter, the product is dried. This gave 5.83 g of a platinum complex having the following formula:

PtCl₂[P(—O-2-tert-butyl-4-ethyl-phenyl)₃]₂.

### Preparation of Catalyst 8

5 ml of a 1.0 molar solution of trimethylaluminium in diethyl ether are added to 2.0 g of a suspension of catalyst 2 in 30 ml of abs. diethyl ether at −20° C. The reaction mixture is warmed to room temperature and then stirred for one hour. After careful addition of 20 ml of water, the ether phase is decanted off. The aqueous phase is extracted three times with 20 ml each time of diethyl ether. The combined organic extracts are dried over anhydrous sodium sulfate. Taking off the solvent gives 1.5 g of a compound of the formula:

Me₂PtPt[P(—O-4-nonylphenyl)₃]₂.

### Preparation of Catalyst 9

7.2 ml of a 2.0 molar solution of methyllithium in diethyl ether are added to 2.0 g of a suspension of catalyst 5 in 30 ml of abs. diethyl ether at −20° C. The reaction mixture is warmed to room temperature and stirred at this temperature for one hour. After careful addition of 20 ml of water, the ether phase is decanted off. The aqueous phase is extracted three times with 20 ml each time of diethyl ether. The combined organic extracts are dried over anhydrous sodium sulfate. Taking off the solvent gives 1.7 g of a compound of the formula:

Me₂PtP(—O-2,4-di-tert-butylphenyl)₃]₂.

### Preparation of Catalyst 10

7.2 ml of a 2.0 molar solution of butyllithium in diethyl ether are added to 2.0 g of a suspension of catalyst 5 in 30 ml of abs. diethyl ether at −20° C. The reaction mixture is warmed to room temperature and stirred at this temperature for one hour. After careful addition of 20 ml of water, the ether phase is decanted off. The aqueous phase is extracted three times with 20 ml each time of diethyl ether. The combined organic extracts are dried over anhydrous sodium sulfate. Taking off the solvent gives 2.1 g of a compound of the formula:

Butyl₂PtP(—O-2,4-di-tert-butylphenyl)₃]₂.

### Example 1

General procedure: 50.0 g of a vinyldimethylsiloxy-terminated polydimethylsiloxane having a viscosity of 20 Pa·s, inhibitor and 1.0 g of SiH crosslinker were homogeneously mixed by means of a stirrer from Janke & Kunkel IKA-Labortechnik, model RE 162; the SiH crosslinker was a copolymer of dimethylsiloxy, methylhydrogensiloxy and trimethylsiloxy units having a viscosity of 330 mPa·s and a content of Si-bonded hydrogen of 0.46% by weight. 10 ppm of platinum complex (based on Pt) were subsequently dissolved in 0.5 ml of dichloromethane, added and stirred in at room temperature.

In example 1, 3 mg of 1-ethynyl-1-cyclohexanol (ECH) as inhibitor component and 3.2 mg of catalyst 1 (corresponding to 10 ppm of Pt) were used.

### Example 2

The procedure described in example 1 is repeated using 20.0 mg of 2-phenyl-3-butyn-2-ol as inhibitor component. 3.2 mg of catalyst 1 are stirred into the mixture.

### Example 3

The procedure described in example 1 is repeated using 3 mg of diethyl maleate as inhibitor component. 3.2 mg of catalyst 1 are stirred into the mixture.

### Example 4

The procedure described in example 1 is repeated using a combination of 2.0 mg of tris(2,4-di-tert-butylphenyl) phosphite and 2.0 mg of diethyl maleate as inhibitor component. 3.2 mg of catalyst 1 are stirred into the mixture.

### Example 5

The procedure described in example 1 is repeated using a combination of 1.0 mg of tris(2,4-di-tert-butylphenyl) phosphite and 1.0 mg of diethyl maleate as inhibitor component. 4.3 mg of catalyst 2 are stirred into the mixture.

### Example 6

The procedure described in example 1 is repeated using 3 mg of ECH as inhibitor component. 5.0 mg of catalyst 3 are stirred into the mixture.

### Example 7

The procedure described in example 1 is repeated using a combination of 1.0 mg of tris(2,4-di-tert-butylphenyl) phosphite and 1.0 mg of diethyl maleate as inhibitor component. 3.9 mg of catalyst 4 are stirred into the mixture.

### Example 8

The procedure described in example 1 is repeated using a combination of 1.0 mg of tris(2,4-di-tert-butylphenyl) phosphite and 1.0 mg of diethyl maleate as inhibitor component. 4.1 mg of catalyst 5 are stirred into the mixture.

### Example 9

The procedure described in example 1 is repeated using 3 mg of ECH as inhibitor component. 3.3 mg of catalyst 6 are stirred into the mixture.

### Example 10

The procedure described in example 1 is repeated using 3 mg of ECH as inhibitor component. 3.6 mg of catalyst 7 are stirred into the mixture.

### Example 11

The procedure described in example 1 is repeated using 3 mg of ECH as inhibitor component. 3.8 mg of catalyst 8 are stirred into the mixture.

### Example 12

The procedure described in example 1 is repeated using a combination of 1.0 mg of tris(2,4-di-tert-butylphenyl) phosphite and 1.0 mg of diethyl maleate as inhibitor component. 3.8 mg of catalyst 9 are stirred into the mixture.

### Comparative Example 1

As comparative example, crosslinking by means of a platinum-divinyltetramethylsiloxane complex (1) is described; despite the addition of inhibiting substances such as ECH, the composition has a short potlife of less than one day at 50° C.

The potlifes were determined by visual assessment of a low-viscosity model formulation; the reaction commencement temperatures are dependant on the method parameters selected and were determined by means of a method based on DIN53529T3.

The following abbreviations are used:

### Ex Example

### cat Catalyst

### inh Inhibitor

ECH 1-ethynyl-1-cyclohexanol
temp Reaction commencement temperature

### Δt Potlife at 50° C.

cat 0 Platinum-divinyltetramethylsiloxane complex, “Karstedt catalyst”
comp 1 Comparative example 1

The reaction commencement temperatures and potlifes of examples 1-10 and of the comparative example are shown in table 1. It can be seen that a potlife of at least 2 days was able to be achieved.

TABLE 1

| Ex. | Cat | Inh | Temp | Δt | |
|---|---|---|---|---|---|
| Comp. | 0 | 1-ethynyl-1-cyclohexanol | 103 | <1 | day |
| 1 | | | | | |
| 2 | 1 | 1-ethynyl-1-cyclohexanol | 119 | 4 | days |
| 3 | 1 | 2-phenyl-3-butyn-2-ol | 125 | 3 | days |
| 4 | 1 | Diethyl maleate | 120 | 2 | days |
| 5 | 1 | Tris(2,4-di-tert-butylphenyl) | 119 | >6 | days |
| | | phosphite, diethyl maleate | | | |
| 6 | 2 | Tris(2,4-di-tert-butylphenyl) | 148 | >6 | days |
| | | phosphite, diethyl maleate | | | |
| 7 | 3 | 1-ethynyl-1-cyclohexanol | 144 | 4 | days |
| 8 | 4 | Tris(2,4-di-tert-butylphenyl) | 133 | >6 | days |
| | | phosphite, diethyl maleate | | | |
| 9 | 5 | Tris(2,4-di-tert-butylphenyl) | 118 | >6 | days |
| | | phosphite, diethyl maleate | | | |
| 10 | 6 | 1-ethynyl-1-cyclohexanol | 159 | >6 | days |
| 11 | 7 | 1-ethynyl-1-cyclohexanol | 124 | 5 | days |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A platinum catalyst (D) of the general formula (I),
R¹₂Pt[P(OR²)₃]₂ (I)
where
R¹ are identical or different and are each, independently of one another,
a halogen,
a singularly negatively charged inorganic radical,
CR³₃ where the radicals R³ are identical or different and are each, independently of one another, H, a linear or branched aliphatic radical having from 1 to 18 carbon atoms or an arylalkyl radical having from 6 to 31 carbon atoms,
OR³ where R³ is as defined above,
SiR³₃ where R³ is as defined above,
the radicals R² are identical or different and are each, independently of one another,
an alkyl radical of the formula CₙH₂ₙ₊₁ where n=5-18 or CₘH₂ₘ₋₁ where m=5-31,
an arylalkyl radical of the formula —(C₆H₅₋ₚ)—(CₒH₂ₒ₊₁)ₚ where o=1-31 and p=1-5,
where R¹ and R² may be unsubstituted or substituted by the groups —NH₂, —COOH, —F, —Br, —Cl, aryl or -alkyl.

2. In a hydrosilylation, hydrogenation, or alkyne oligomerization reaction wherein a platinum catalyst is used, the improvement comprising employing at least one platinum catalyst of claim 1.

3. An addition-crosslinking silicone composition comprising
at least one component of each of (A), (B) and (D),
at least one component of each of (C) and (D), or
at least one component of each of (A), (B), (C) and (D)
where
(A) is an organic compound or an organosilicon compound comprising at least two radicals having aliphatic carbon-carbon multiple bonds,
(B) is an organosilicon compound containing at least two Si-bonded hydrogen atoms,
(C) is an organosilicon compound containing SiC-bonded radicals having aliphatic carbon-carbon multiple bonds and Si-bonded hydrogen atoms, and
(D) is a platinum catalyst,
wherein at least one platinum catalyst (D) is a platinum catalyst of claim 1.

4. The addition-crosslinking silicone composition of claim 3 which contains, as a further component (E), at least one inhibitor or stabilizer in a proportion of from 0.00001% to 5% based on the total weight of the composition.

5. The addition-crosslinking silicone composition of claim 3, which contains at least one further component (F) selected from the group consisting of reinforcing and nonreinforcing fillers, dispersants, solvents, bonding agents, pigments, dyes, plasticizers, organic polymers, heat stabilizers, fungicides, fragrances, rheological additives, corrosion inhibitors, oxidation inhibitors, light stabilizers, flame retardants, and agents for influencing electrical properties.

6. The addition-crosslinking silicone composition of claim 3, which contains at least one addition-crosslinking catalyst (G) as a further constituent.

7. A process for producing an addition-crosslinking silicone composition of claim 3, wherein the components used of (A), (B), (C), and (D) are mixed with one another.

8. The process of claim 7, wherein one or more further components selected from the group consisting of
(E) inhibitor(s) and/or stabilizer(s);
(F) reinforcing and nonreinforcing fillers, dispersants, solvents, bonding agents, pigments, dyes, plasticizers, organic polymers, heat stabilizers, fungicides, fragrances, rheological additives, corrosion inhibitors, oxidation inhibitors, light stabilizers, flame retardants, and agents for influencing electrical properties, and
(G) addition-crosslinking catalyst(s).

9. A shaped body, impression, seal, embedding material, potting material, coating, or impregnant, comprising a composition of claim 3.
